(19) United States
(12) Patent Application Publication
(10) Pub. No.: US 2006/0126180 A1
(43) Pub. Date: Jun. 15, 2006

(54) Objective lens system and optical pickup apparatus using the same

(75) Inventors: Mee-suk Jung, Suwon-si (KR); Myung-bok Lee, Suwon-si (KR); Jin-seung Sohn, Seoul (KR); Eun-hyoung Cho, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electro-Mechanics Co., LTD.

(21) Appl. No.: 11/289,361

(22) Filed: Nov. 30, 2005

(30) Foreign Application Priority Data
Dec. 9, 2004 (KR) 10-2004-0103669

(51) Int. Cl. G02B 27/44

(52) U.S. Cl. 359/565

(57) ABSTRACT

An objective lens system and an optical pickup apparatus using the same are provided. The objective lens system includes a diffractive optical element, and a half-ball lens disposed between the diffractive optical element and the medium, the half-ball lens having a spherical surface on a side facing the diffractive optical element, and an aspheric membrane formed on the spherical surface of the half-ball lens. The aspheric membrane comprises a plastic material or an ultraviolet-cured resin. The optical pickup apparatus includes a light source, an optical path converter disposed between the light source and an information storage medium, the above-described objective lens system disposed between the optical path converter and the information storage medium, and a photodetector which receives light reflected from the information storage medium and passed through the objective lens system and the optical path converter and which detects an information signal and an error signal.

### CROSS REFERENCE TO RELATED APPLICATIONS

This application claims the benefit of Korean Patent Application No. 10-2004-0103669, filed on Dec. 9, 2004, in the Korean Intellectual Property Office, the disclosure of which is incorporated herein in its entirety by reference.

### BACKGROUND OF THE INVENTION

1. Field of the Invention

The present invention relates to an objective lens system and an optical pickup apparatus using the same, and more particularly, to an objective lens system having a structure facilitating the implementation of an aspheric surface and allowing chromatic aberration to be compensated for, and an optical pickup apparatus using the same.

2. Description of the Related Art

Objective lens systems are widely used in an optical pickup apparatuses which records/reproduces information onto/from an information storage medium using a laser beam. With industrial development, an information storage medium to record more information into a limited area is increasingly needed. Accordingly, as an information storage medium, a disc having a diameter of 120 mm has evolved from the compact disc (CD) having a capacity of about 700 MB. The 120 mm disk, as a digital versatile disc (DVD), has a capacity of about 4.7 GB and as a Blu-ray disc (BD), has a capacity of about 20 GB or greater.

To implement a high-density information storage medium like a BD, it is necessary to reduce the size of a light spot formed on the information storage medium. Here, the size of the light spot is in proportion to the wavelength of a laser beam emitted from a light source of an optical pickup apparatus and is in inverse proportion to the numerical aperture of an objective lens system. However, as the numerical aperture of an objective lens increases, the eccentricity between opposite sides of the objective lens or an error in the distance therebetween also increases, and therefore, optical aberration including spherical aberration and coma aberration increases. In addition, since a blue-wavelength laser diode sensitively changes in wavelength according to the change in temperature, aberration compensation, i.e., chromatic aberration compensation, must be considered when the objective lens is designed. The wavelength of the laser diode increases 0.07 nm per degree of temperature in Celsius. For example, when the temperature increases from a room temperature of 25° C. to 85° C., the wavelength changes by approximately 4.2 nm. Thus, when the laser diode has a wavelength of 407 nm, the wavelength changes to approximately 411. 2 nm. Further, when considering even a small wavelength change of 1.5 nm, due to the mode hopping of the laser diode that an optical pickup actuator cannot follow, the wavelength becomes approximately 412.7 nm with a very large wavelength change of 5.7 nm. Accordingly, when designing the objective lens of an optical pickup using a blue wavelength, the above-described characteristics and aberration need to be considered. Here, the structure of the objective lens is most important.

A conventional objective lens system having a high numerical aperture will be described with reference to FIGS. 1A through 1C.

Referring to FIG. 1A, to achieve a high numerical aperture and aberration compensation, a conventional objective lens system includes a plano-convex type spherical lens 11 and a diffractive optical element (DOE) 13 formed on one side of the spherical lens 11. This conventional objective lens system has a short radius of curvature, thereby increasing the numerical aperture, and reduces chromatic aberration by using the DOE 13. However, the conventional objective lens system cannot compensate for other aberration with only the spherical lens 11.

Referring to FIG. 1B, another conventional objective lens system includes a single lens 20 having a spherical incident surface 21 and an aspheric exit surface 23. Here, the numerical aperture can be increased by shortening the radius of curvature of the incident surface 21, and aberration can be decreased by making the exit surface 23 aspheric. However, an objective lens with only a spherical surface and an aspheric surface cannot compensate for chromatic aberration in a blue wavelength band of a light source used for a high numerical aperture.

Referring to FIG. 1C, still another conventional objective lens system includes a single aspheric lens 30 having an incident surface 31 and an exit surface 33 which are both aspheric. When the aspheric lens 30 having the aspheric incident and exit surfaces 31 and 33 at opposite sides, respectively, is manufactured, two core molds requiring high precision need to be prepared and it takes a large amount of time and labor to align the core molds so that the optical axes of both aspheric surfaces coincide. As a result, mass productivity is decreased. In addition, it is difficult to manufacture ultra-precision aspheric surfaces, and desired chromatic compensation cannot be accomplished.

### SUMMARY OF THE INVENTION

The present invention provides an objective lens system having a structure facilitating the implementation of an aspheric surface and allowing chromatic aberration and wavefront error to be compensated for, and an optical pickup apparatus using the same.

According to an exemplary aspect of the present invention, there is provided an objective lens system, which focuses light onto a medium. The objective lens system includes a diffractive optical element which compensates for chromatic aberration and for a wavefront error in incident light; a refractive lens, disposed between the diffractive optical element and the medium, and which condenses incident light; and a thin aspheric membrane formed on one surface of the refractive lens which compensates for a wavefront error.

According to another exemplary aspect of the present invention, there is provided an objective lens system, which focuses light onto a medium. The objective lens system includes a diffractive optical element which compensates for chromatic aberration and for a wavefront error in incident light; a half-ball lens disposed between the diffractive optical element and the medium and which condenses incident light, the half-ball lens including a spherical surface on a first side facing the diffractive optical element; and a thin aspheric membrane formed on the spherical surface of the half-ball lens which compensates for a wavefront error. The aspheric member is one of a plastic material and an ultraviolet-cured resin.

According to still another exemplary aspect of the present invention, there is provided an optical pickup apparatus for recording and/or reproducing information onto and/or from an information storage medium. The optical pickup apparatus includes a light source which generates and emits light having a predetermined wavelength; an optical path converter disposed between the light source and the information storage medium which converts a progressing path of incident light; an objective lens system disposed between the optical path converter and the information storage medium; and a photodetector which receives light that has been reflected from the information storage medium and passed through the objective lens system and the optical path converter and which detects an information signal and an error signal. The objective lens system includes a diffractive optical element which compensates for chromatic aberration and a wavefront error in incident light; a refractive lens, disposed between the diffractive optical element and the information storage medium, which condenses incident light; and a thin aspheric membrane formed on one surface of the refractive lens which compensates for a wavefront error.

According to yet another exemplary aspect of the present invention, there is provided an optical pickup apparatus for recording and/or reproducing information onto and/or from a Blu-ray disc. The optical pickup apparatus includes a light source which generates and emits light having a wavelength of about 405 nm; an optical path converter, disposed between the light source and the Blu-ray disc, which converts a progressing path of incident light; an objective lens system disposed between the optical path converter and the Blu-ray disc; and a photodetector which receives light that has been reflected from the Blu-ray disc and passed through the objective lens system and the optical path converter and which detects an information signal and an error signal. The objective lens system includes a diffractive optical element which compensates for chromatic aberration and a wavefront error in incident light; a half-ball lens, disposed between the diffractive optical element and the Blu-ray disc, which condenses incident light and which includes a spherical surface on a side facing the diffractive optical element; and a thin aspheric membrane formed on the spherical surface of the half-ball lens, which compensates for a wavefront error and which comprises one of a plastic material and an ultraviolet-cured resin.

### BRIEF DESCRIPTION OF THE DRAWINGS

The above and other features and advantages of the present invention will become more apparent by a detailed description of exemplary embodiments thereof with reference to the attached drawings in which:

FIGS. 1A through 1C illustrate the optical arrangement of conventional objective lens systems;

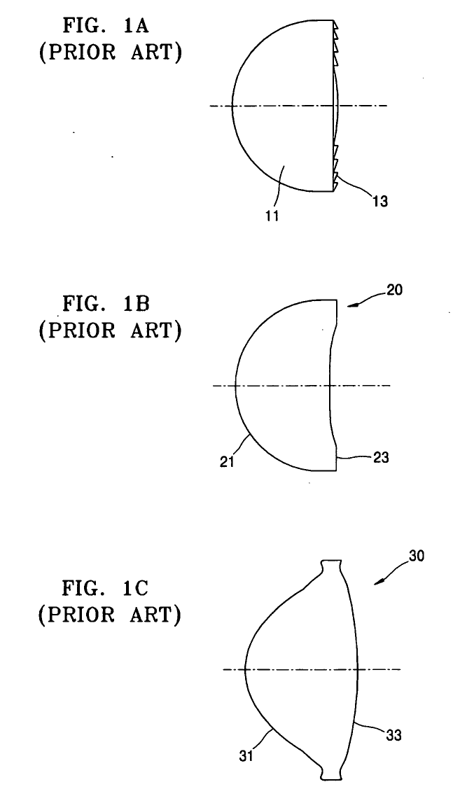

FIGS. 2 and 3 illustrate the optical arrangement of an objective lens system according to an exemplary embodiment of the present invention; and

FIG. 4 illustrates the optical arrangement of an optical pickup apparatus according to an exemplary embodiment of the present invention.

### DETAILED DESCRIPTION OF THE INVENTION

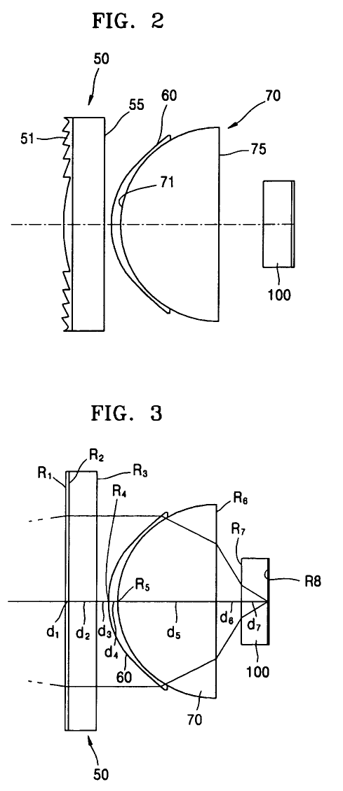

FIG. 2 is a sectional view showing the optical arrangement of an objective lens system according to an exemplary embodiment of the present invention. Referring to FIG. 2, the objective lens system is disposed on a light path to condense light onto a medium 100, e.g., a Blu-ray disc (BD), and includes a diffractive optical element (DOE) 50, a refractive lens 70, and an aspheric member 60 formed on one surface of the refractive lens 70 to compensate for a wavefront error. The objective lens system may have a numerical aperture of about 0.85 or greater to minimize the size of a light spot formed on the medium 100.

The refractive lens 70 is disposed on an optical path between the DOE 50 and the medium 100 to condense incident light. The refractive lens 70 is a spherical lens having a spherical surface 71, at a side facing the DOE 50, and a flat surface 75 at an opposite side, facing the medium 100. That is, the refractive lens 70 is a half-ball lens. The refractive lens 70 may be implemented as an N-LASF44 having a refractive index of 1.804, a transmittance of 96.1%, and an abbe value of 46.5 with respect to an incident light having a wavelength of 405 nm. The aspheric member 60 is formed on the spherical surface 71 of the refractive lens 70 in the form of a thin aspheric membrane and compensates for a wavefront error generated in the refractive lens 70.

The aspheric member 60 is formed by coating the spherical surface 71 of the refractive lens 70 with a thin aspheric membrane. The aspheric member 60 may be made using a plastic material such as a photo polymer or an ultraviolet-cured polymer, or another polymer as would be understood by one of skill in the art. Here, a coating process performed on the refractive lens 70 to form the aspheric member 60 is widely known, and thus, a detailed description thereof will be omitted.

The aspheric member 60 has a curvature satisfying Equation 1.

$$X ( y ) = \frac{{Cy}^{2}}{1 + {[ 1 - ( K + 1 ) {C}^{2} {y}^{2} ]}^{1 / 2}} + {A}_{4} {y}^{4} + {A}_{6} {y}^{6} + {A}_{8} {y}^{8} + ⋯ \\ = \frac{{Cy}^{2}}{1 + {[ 1 - ( K + 1 ) {C}^{2} {y}^{2} ]}^{1 / 2}} + {\sum }_{n = 2}^{∞} {A}_{2 n} {y}^{2 n} \qquad ( 1 )$$

where X(y) is an aspheric equation indicating a depth from a vertex of the aspheric member 60 to a plane thereof in a direction parallel to an optical axis, y is a height from the optical axis, C is a reciprocal of the radius of curvature at the vertex of the aspheric member 60, K is a conic constant, and A₄, A₆, A₈, and A₂ₙ are aspheric coefficients.

Manufacturing the half-ball lens and the thin aspheric membrane on the spherical surface of the half-ball lens is easy and costs less than manufacturing a conventional single aspheric lens.

The DOE 50 is a flat optical element including a Fresnel lens 51 on one side and a flat surface 55 on an opposite side. The flat surface 55 may be disposed to face the refractive lens 70.

The DOE 50 compensates for chromatic aberration when a wavelength of light emitted from a light source changes. In addition, since the DOE 50 has some refractive power along with the refractive lens 70 and the aspheric member 60, it also compensates for a wavefront error. In other words, the refractive lens 70 is a typical one and has a focal length f_{ref} proportional to the wavelength of incident light. The refractive index n of the refractive lens 70 decreases as the wavelength of light increases. Accordingly, due to the wavelength tolerance of the light source, the focal length of the refractive lens 70 is longer when the incident light has a wavelength longer than a standard wavelength of 405 nm for a BD than it is when the incident light has the standard wavelength of 405 nm for a BD. As a result, chromatic aberration occurs. That is, an imaging position changes according to the change in the wavelength of light emitted from the light source. Here, the degree of chromatic aberration (i.e., a focal position difference due to a wavelength change) is determined by the abbe value V_{ref} (=(n-1)/Δn) of the refractive lens 70.

Unlike the refractive lens 70, the DOE 50 has a focal length f_{doe} inversely proportional to the wavelength of incident light. For example, the focal length of the DOE 50 is shorter when the incident light has a wavelength (e.g., 410 nm) greater than 405 nm than when the incident light has a wavelength of 405 nm. Here, the change in the focal length due to the wavelength change is determined by v_{doe} (=λ/Δλ) of the DOE 50.

The focal length f of the entire objective lens system is expressed by Equation 2.

$$\frac{1}{f} = \frac{1}{{f}_{ref}} + \frac{1}{{f}_{doe}} \qquad ( 2 )$$

Accordingly, the chromatic aberration of the refractive lens 70 can be compensated for by setting the abbe values v_{ref} and v_{doe} to satisfy Equation 3. Consequently, due to a wavelength tolerance for light emitted from the light source, the objective lens system according to an embodiment of the present invention enables an image to be formed at the same position even when the wavelength of the light varies, as shown by Equation 3.

$$\frac{1}{{f}_{ref} {v}_{ref}} + \frac{1}{{f}_{doe} {v}_{doe}} = 0 \qquad ( 3 )$$

The Fresnel lens 51 may be implemented by forming diverse diffractive patterns. Examples of a diffractive pattern may be a kinoform formed using diamond processing, a zone plate, a binary optic formed using photolithography, and a multi-level DOE formed using photolithography. In embodiments of the present invention set forth below, the Fresnel lens 51 has a multi-level pattern, i.e., an 8-phase level pattern, which can be expressed as a radial symmetric function Φ(r) with respect to a wavefront, as shown in Equation 4.

$$Φ ( r ) = \frac{2 π}{{λ}_{0}} ( {C}_{1} {r}^{2} + {C}_{2} {r}^{4} + {C}_{3} {r}^{6} + ⋯ ) \\ = \frac{2 π}{{λ}_{0}} {\sum }_{n = 1}^{∞} {C}_{n} {r}^{2 n} \qquad ( 4 )$$

where λ₀ is a reference wavelength; C₁, C₂, C₃, and Cₙ are DOE coefficients, and r is a radius from the optical axis.

Meanwhile, the DOE 50 may have the Fresnel lens 51 at a side facing the refractive lens 70 and having a flat surface 55 at an opposite side.

The details of the objective lens system according to the exemplary embodiment illustrated in FIG. 2 are shown in Tables 1 and 2 and in FIG. 3.

TABLE 1

| | Radius of | Thickness or | |
|---|---|---|---|
| Elements | curvature (mm) | distance (mm) | Material |
| Object | ∞ | 4.0191 | |
| DOE | R₁ = ∞ | d₁ = 0.0100 | PMMA |
| | R₂ = ∞ | d₂ = 0.1000 | F silica |
| Stop | R₃ = ∞ | d₃ = 0.0500 | |
| Aspheric member | R₄ = 0.3133 | d₄ = 0.0550 | Photo polymer |
| Objective lens | R₅ = 0.4495 | d₅ = 0.4495 | N-LASF44 |
| | R₆ = ∞ | d₆ = 0.1000 | |
| Medium | R₇ = ∞ | d₇ = 0.1000 | Polycarbonate |
| Image | R₈ = ∞ | — | |

TABLE 2

| | |
|---|---|
| DOE | Aspheric surface |

| Parameters | Values | Parameters | Values |
|---|---|---|---|
| Diffraction order | 1 | Radius | 0.3133 mm |
| Wavelength | 405.0 nm | K | −0.5617 |
| C₁ | −0.1200 | A₄ | −0.0555 |
| C₂ | −0.0763 | A₆ | −4.3806 |
| C₃ | 0.4163 | A₈ | 33.6234 |
| C₄ | −1.8117 | A₁₀ | −454.1661 |
| C₅ | 5.6598 | A₁₂ | 0.0000 |
| C₆ | 0.0000 | A₁₄ | 0.0000 |

When the objective lens system was implemented as shown in Tables 1 and 2, it had an on-axis wavefront error of 0.0149 λ, an off-axis wavefront error of 0.0169 λ, and a chromatic aberration of 0.00247 with respect to incident light having a wavelength of 405 nm. These wavefront errors and chromatic aberration are so small as to be ignorable.

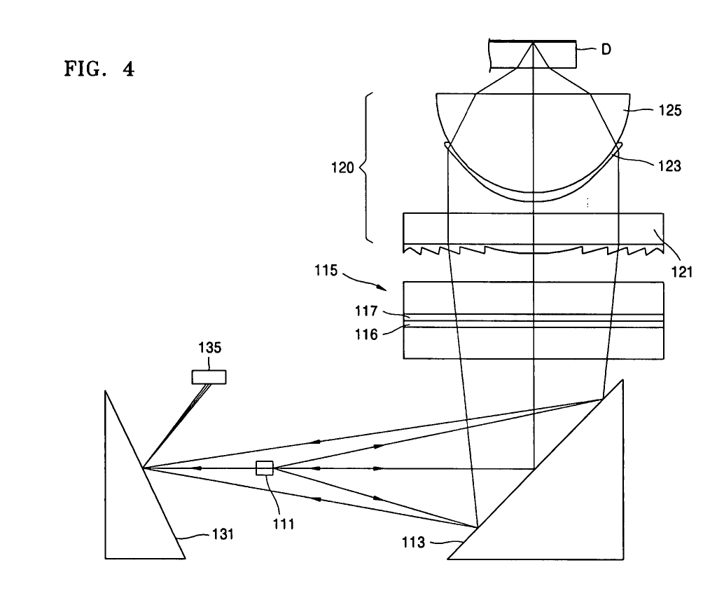

Referring to FIG. 4, an optical pickup apparatus according to an exemplary embodiment of the present invention records and/or reproduces information onto and/or from an information storage medium D and includes a light source 111, an optical path converter 115, an objective lens system 120, and a photodetector 135.

The light source 111 generates and emits light having a predetermined wavelength. The light source 111 may include a laser diode (LD), emitting light having a wavelength of about 405 nm, so that information can be recorded and/or reproduced even when a BD is used as the information storage medium D. The optical path converter 115 is disposed on an optical path between the light source 111 and the objective lens system 120 to convert the progressing path of incident light. The optical path converter 115 may include a polarized holographic optical element (HOE) 116 and a ¼-wavelength plate 117.

The polarized HOE 16 linearly transmits light with one polarization and diffracts light with the other polarization, thereby converting the progressing path of light. In other words, the polarized HOE 116 linearly transmits light with one linear polarization incident from the light source 111 and diffracts light with the other linear polarization incident from the information storage medium D. The ¼-wavelength plate 117 is provided on one side of the polarized HOE 116. The ¼-wavelength plate 117 delays the phase of incident light to convert linearly polarized light into circularly polarized light and to convert circularly polarized light into linearly polarized light. Here, light that has been emitted from the light source 111 and then reflected from the information storage medium D passes through the ¼-wavelength plate 117 two times, and therefore, the phase of the light changes by ½ wavelength. As a result, light incident from the ¼-wavelength plate 117 has different linear polarization than light incident from the light source 111.

The objective lens system 120 is disposed between the light source 111 and the information storage medium D. The objective lens system 120 includes a DOE, which compensates for chromatic aberration and wavefront errors in incident light, a refractive lens 125, disposed between the DOE 121 and the information storage medium D to condense incident light, and an aspheric member 123 formed on one surface of the refractive lens 125.

The refractive lens 125 is a half-ball lens having a spherical surface at the side facing the DOE 121. The aspheric member 123 is formed on the spherical surface of the half-ball lens in the form of a thin aspheric membrane to compensate for a wavefront error. The objective lens system 120 is substantially the same as the objective lens system described with reference to FIGS. 2 and 3. Thus, a detailed description thereof will be omitted.

The photodetector 135 receives light that has been reflected from the information storage medium D and passed through the objective lens system 120 and the optical path converter 115 and detects an information signal and an error signal. In addition, with consideration of the optical disposition of the photodetector 135, the optical pickup apparatus may further include a first reflecting mirror 113 and a second reflecting mirror 131, which convert the progressing path of incident light.

As described above, an objective lens system according to the present invention includes a refractive lens, an aspheric member, and a DOE which are sequentially disposed from a medium, thereby facilitating the optical arrangement of optical elements. In addition, the refractive lens is implemented as a half-ball lens having on one surface thereof the aspheric member implemented as a thin aspheric membrane, thereby compensating for a wavefront error, facilitating mass production, and reducing manufacturing costs. Moreover, chromatic aberration can be compensated for using the DOE and a wavefront error can be compensated for using the DOE and the refractive lens.

An optical pickup apparatus according to the present invention includes the objective lens system according to the present invention, thereby maintaining a high numerical aperture and compensating for chromatic aberration and wavefront errors. Accordingly, the optical pickup apparatus can record and/or reproduce information into and/or from even a BD having a capacity of about 20 GB or more.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An objective lens system, which focuses light onto a medium, comprising:
a diffractive optical element;
a refractive lens disposed between the diffractive optical element and the medium; and
a thin aspheric membrane formed on a surface of the refractive lens.

2. The objective lens system of claim 1, wherein the refractive lens is a half-ball lens having a flat surface at a first side facing the medium and a spherical surface at a second side facing the diffractive optical element.

3. The objective lens system of claim 2, wherein the aspheric membrane is formed on the spherical surface of the half-ball lens.

4. The objective lens system of claim 1, wherein the aspheric membrane comprises a plastic material.

5. The objective lens system of claim 4, wherein the aspheric membrane comprises a photo polymer.

6. The objective lens system of claim 1, wherein the aspheric membrane comprises an ultraviolet-cured resin.

7. The objective lens system of claim 1, wherein the diffractive optical element comprises a flat surface on a first side facing the refractive lens and a Fresnel lens on a second side opposite to the first side.

8. The objective lens system of claim 1, wherein the diffractive optical element comprises a Fresnel lens a first side facing the refractive lens and a flat surface on a second side opposite to the first side.

9. An objective lens system, which focuses light onto a medium, comprising:
a diffractive optical element;
a half-ball lens disposed between the diffractive optical element and the medium, the half-ball lens comprising a spherical surface on a side facing the diffractive optical element; and
a thin aspheric membrane formed on the spherical surface of the half-ball lens, the aspheric member comprising one of a plastic material and an ultraviolet-cured resin.

10. An optical pickup apparatus for an information storage medium, the optical pickup apparatus comprising:
a light source which emits light of a predetermined wavelength;
an optical path converter disposed between the light source and the information storage medium;
an objective lens system disposed between the optical path converter and the information storage medium, the objective lens system comprising:
a diffractive optical element,
a refractive lens disposed between the diffractive optical element and the information storage medium, and
a thin aspheric membrane formed on a surface of the refractive lens; and
a photodetector which receives light that has been reflected from the information storage medium and passed through the objective lens system and the optical path converter, and which detects an information signal and an error signal.

11. The optical pickup apparatus of claim 10, wherein the refractive lens is a half-ball lens having a flat surface at a first side facing the information storage medium and a spherical surface at a second side facing the diffractive optical element.

12. The optical pickup apparatus of claim 10, wherein the aspheric membrane comprises a plastic material.

13. The optical pickup apparatus of claim 12, wherein the aspheric membrane comprises a photo polymer.

14. The optical pickup apparatus of claim 10, wherein the aspheric membrane comprises an ultraviolet-cured resin.

15. The optical pickup apparatus of claim 10, wherein the diffractive optical element comprises a flat surface on a first surface facing the refractive lens and a Fresnel lens on a second surface opposite to the first surface.

16. The optical pickup apparatus of claim 10, wherein the diffractive optical element comprises a Fresnel lens on a first surface facing the refractive lens and a flat surface on a second surface opposite to the first surface.

17. An optical pickup apparatus for a Blu-ray disc, the optical pickup apparatus comprising:
a light source which emits light having a wavelength of about 405 nm;
an optical path converter disposed between the light source and the Blu-ray disc;
an objective lens system disposed between the optical path converter and the Blu-ray disc, the objective lens system comprising:
a diffractive optical element;
a half-ball lens, having a spherical surface disposed on a side facing the diffractive optical element, disposed between the diffractive optical element and the Blu-ray disc; and
a thin aspheric membrane formed on the spherical surface of the half-ball lens, the aspheric membrane comprising one of a plastic material and an ultraviolet-cured resin; and
a photodetector which receives light that has been reflected from the Blu-ray disc and passed through the objective lens system and the optical path converter, and which detects an information signal and an error signal.

18. An objective lens system, which focuses light onto a medium, comprising:
a first means for compensating for chromatic aberration and wavefront error in incident light;
a second means for condensing incident light disposed between the first means and the medium; and
a third means for compensating for wavefront error, disposed on a surface of the second means.

19. An optical pickup apparatus, for an information storage medium, comprising:
a first means for emitting light of a predetermined wavelength;
a second means for converting a progressing path of incident light;
an objective lens means, comprising:
a third means for compensating for chromatic aberration, disposed between the second means and the information storage medium,
a fourth means for condensing incident light, disposed between the third means and the information storage medium, and
a fifth means for compensating for a wavefront error, disposed on a surface of the fourth means; and
a sixth means for receiving light, which has been reflected from the information storage medium and passed through the objective lens means and the second means, and for detecting an information signal and an error signal.
